(19) United States
(12) Patent Application Publication
(10) Pub. No.: US 2018/0355170 A1
(43) Pub. Date: Dec. 13, 2018

(54) THERMALLY-CONDUCTIVE POLYMER COMPOSITES

(71) Applicant: SABIC Global Technologies B.V., Bergen op Zoom (NL)

(72) Inventors: Yaqin ZHANG, Shanghai (CN); Mingcheng GUO, Shanghai (CN); Haowei TANG, Shanghai (CN); Shan QIN, Shanghai (CN); Shengying QIAN, Shanghai (CN)

(21) Appl. No.: 15/580,501

(22) PCT Filed: Jun. 27, 2016
(86) PCT No.: PCT/IB2016/053829

§ 371 Date: Dec. 7, 2017

Related U.S. Application Data
(60) Provisional application No. 62/185,817, filed on Jun. 29, 2015.

(51) Int. Cl. C08L 77/00; C08L 69/00; C08L 71/02; C08L 65/02; C08L 23/16; C08L 23/08; C08K 5/09; C08K 5/17; C08K 5/42; C08K 5/1515; C08K 3/22; C08K 3/38

(52) U.S. Cl. CPC C08L 77/00; C08K 2201/001; C08L 71/02; C08L 65/02; C08L 23/16; C08L 23/0815; C08K 5/09; C08K 5/17; C08K 5/42; C08K 5/1515; C08K 3/22; C08K 3/38; C08K 2003/2224; C08K 2003/385; C08L 69/00

(57) ABSTRACT

The present disclosure is directed to polymer composites, and, particularly, thermally conductive polymer composites. The polymer composites can include from about 20 wt. % to about 80 wt. % of a base polymer resin; from about 1 wt. % to about 70 wt. % of thermoconductive filler material comprising thermoconductive particles having a plurality of electronegative functional groups at the surface of the particles, and having a thermal conductivity of at least 2 W/m*K; from about 0.01 wt. % to about 20 wt. % of an amphiphilic compatibilizer including a hydrophilic component and hydrophobic chain component; and, optionally, from about 0 wt. % to 50 wt. % of an additive. As compared to a control composition having 0.00 wt. % of the amphiphilic compatibilizer, the composite has (i) increased mechanical strength as measured by Izod impact testing, and, (ii) increased thermal conductivity as measured by through-plane or in-plane testing.

### RELATED APPLICATION

The present application claims priority to and the benefit of U.S. Patent Application No. 62/185,817, filed Jun. 29, 2015, the entirety of which is incorporated herein by reference for any and all purposes.

### TECHNICAL FIELD

This disclosure is directed to thermally-conductive polymer composites including a polymer resin, a thermoconductive filler, and a compatibilizer.

### BACKGROUND

The commercial use of thermally-conductive polymer composites is expanding, and there is an increasing awareness of improving the performance of these composites, as well as applying these composites to new industries and technologies that have been, to date, unable to utilize polymer composites in place of typical industry-standard materials because of the composites inability to meet certain mechanical performance characteristics. Thermally-conductive polymer compositions for dissipating heat are of interest in a number of applications, such as, for example, microelectronic devices such as semiconductors, microprocessors, resistors, circuit boards, and integrated circuit elements. Thermally conductive polymer compositions are also used to make motor parts, lighting fixtures, optical heads, medical devices, and components for use in conjunction with a number of products, for example in the field of flame retardants.

Although thermally-conductive polymer composites have been widely described in the prior art, these compositions may not have the necessary mechanical properties to be properly utilized. Current compositions and manufacturing processes for thermally-conductive polymer composites can suffer from competing needs of optimizing thermal conductivity while maintaining certain levels of mechanical performance. For example, in certain thermally-conductive composites, a high mass loading of thermoconductive filler will be added to a polymer resin in order to optimize the thermal conductivity of the resultant composite. However, such a blended composite can suffer from poor integration and poor bonding between the materials, which can adversely affect the mechanical properties of the resultant composite. Accordingly, there is a need in the art for polymer composites than can provide improved thermal conductivity while maintaining or increasing the composites overall mechanical properties and performance.

### SUMMARY

The present disclosure is directed to polymer composites, and more particularly, thermally-conductive polymer composites, including a base polymer resin, a thermoconductive filler material such as thermoconductive particles, a compatibilizer, and optionally, an additive. The thermally-conductive polymer composites, according to the present disclosure, when compared to a control composition containing no (0.00 wt. %) compatibilizer, have increased mechanical strength as measured by Izod impact testing, and, increased thermal conductivity as measured by through-plane and in-plane testing.

According to one embodiment, the polymer composite includes from about 20 wt. % to about 80 wt. % of a base polymer resin; from about 1 wt. % to about 70 wt. % of a thermally conductive filler material, such as thermoconductive particles, having a plurality of electronegative functional groups at the surface of the particles, and having a thermal conductivity of at least 2 W/m*K; from about 0.01 wt. % to about 20 wt. % of an amphiphilic compatibilizer having a hydrophobic component and a hydrophilic component; and, optionally, from about 0 wt. % to 50 wt. % of an additive; wherein the combined weight percent value of all components does not exceed about 100 wt. %, and wherein all weight percent values are based on the total weight of the composition.

The addition of the compatibilizer, according to one embodiment, reduces phase boundaries in the polymer composite that result from the integration of the thermoconductive particles, on the one hand, and the base polymer resin, on the other hand. The compatibilizer has, according to another embodiment, an amphiphilic structure that allows an otherwise partially, or totally, immiscible blend of a thermoconductive particle and a base polymer resin to interact by reducing the surface tension between the respective components, which can result in a more stable morphology for the disclosed thermally-conductive composites, and as a result can increase the mechanical performance of the disclosed thermally-conductive polymer composite.

According to a further embodiment, an article of manufacture is disclosed, the article formed from the thermally-conductive polymer composite. In a preferred embodiment, the article is a molded article.

### DETAILED DESCRIPTION

In this document, the terms “the” “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. It is also to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination.

When a range of values is expressed, another embodiment includes from the one particular value and/or to the other particular value. Similarly, when values are expressed as approximations, by use of the antecedent “about,” it will be understood that the particular value forms another embodiment. The modifier “about” used in connection with a quantity is inclusive of the stated value and has the meaning dictated by the context (e.g., it includes the degree of error associated with measurement of the particular quantity based upon the instrumentation or methodology used to obtain the data). All ranges disclosed herein are inclusive of the endpoints, and the endpoints are independently combinable with each other. Further, reference to values stated in ranges includes each and every value within that range. For example, if a range is disclosed having a first endpoint 10, and second endpoint 15, then 11, 12, 13, and 14 are also disclosed.

As used herein the terms “weight percent,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight

As used herein “aromatic polymers” includes polymers having at least one repeating base unit including an aromatic ring. The aromatic polymers described herein can include substituted or unsubstituted rings, monocyclic or polycyclic repeating units, and can include homocyclic rings as well as heterocyclic rings.

As used herein “electronegative functionality” and derivations of the same, includes molecules, ions (both monoatomic and polyatomic), functional groups, and other chemical moieties that have an unequal sharing or distribution of electrons resulting in a separation of electric charge. It should be understood that the term “electronegative functionality is intended to encompass negatively charged functionality, as well as positively charged functionality, such that, for example, both an ammonium ion (NH₄⁺) and a carboxylate ion (COO⁻) would equally be considered to have “electronegative functionality” as the term is intended to be used herein.

It is understood that within this disclosure, where combinations, compounds, subsets, interactions, groups, etc. of compositions and/or materials are disclosed with specific reference, each of the various individual and collective combinations and permutation of these compositions may not be explicitly disclosed, each is specifically contemplated as if it was described herein. Thus, if a class of base polymer resins A, B, and C are disclosed as well as a class of thermoconductive particles D, E, and F, and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; and D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

It is understood that within this disclosure, where reference is made to a “control composition,” in comparison to a described composition according to the present disclosure, the difference (whether chemical or physical in nature) between the two compositions will be particularly recited with respect to that feature. For example, if a described embodiment of the present disclosure recites a composition containing the components A, B, and C, where the recited components taken together equal 100 weight percent (wt. %) of the composition, and the control composition specifically recites the absence or lack of component C, it is understood that the remaining components A and B of the control composition will, taken together, equal 100 wt. % of the control composition, unless explicitly stated to the contrary.

According to the present disclosure, a polymer composite is described; in an exemplary embodiment the polymer composite is a thermally-conductive polymer composite. The polymer composite includes a base polymer resin, a thermoconductive filler material of thermoconductive particles, a compatibilizer, and optionally, an additive. The thermally conductive polymer composites, according to the present disclosure, when compared to a control composition containing no (0.00 wt. %) compatibilizer, have increased mechanical strength as measured by Izod impact testing (both notched and unotched Izod impact tests, as will be described more fully below), and, increased thermal conductivity as measured both by through-plane and in-plane testing (as will be described more fully below).

According to one embodiment, the polymer composite includes from about 20 wt. % to about 80 wt. % of a base polymer resin; from about 1 wt. % to about 70 wt. % of a thermally conductive filler material, such as thermoconductive particles, having a plurality of electronegative functional groups at the surface of the particles, and having an inherent thermal conductivity of at least 2 W/m*K; from about 0.01 wt. % to about 20 wt. % of an amphiphilic compatibilizer having a hydrophobic component and a hydrophilic component; and, optionally, from about 0 wt. % to 50 wt. % of an additive; wherein the combined weight percent value of all components does not exceed about 100 wt. %, and wherein all weight percent values are based on the total weight of the composition.

### Base Polymer Resin

A non-limiting and exemplary list of suitable polymer compositions that constitute the base polymer resin, according to the present disclosure, can include polyalkenes, polyethers, polycarbonates, polyamides, polyimides, polyesters, polyacrylates, aromatic polymers, polyurethanes, thermosets, or copolymers or mixtures of any of the foregoing. It should be appreciated that specific polymer compositions recited herein can, by the nature of the particular repeating unit or units that constitute the specific polymer composition, be consider to fall within more than one of the generally disclosed class of polymers compositions recited herein. For example styrene-based polymers can be included within the class of polyalkenes as well as aromatic polymers. Similarly, the group of polymers classified as polyaryletherketones, such as, for example PEEK (polyetheretherketone), can be included within the class of polyethers as well as aromatic polymers.

According to one embodiment, the polymer composition constituting the base polymer resin can include polyalkenes, for example, polypropylene, polyethylene, or other ethylene-based copolymers; polycarbonates; polyamides, for example nylon 6 (PA6); polyesters, for example, polybutylene terephthalate (PBT), polyethylene terephthalate (PET), or polycyclohexylendimethylene terephthalate (PCT); polyacrylates, for example polymethyl (meth)acrylates such as PMMA; or aromatic polymers, for example, liquid crystal polymers (LPC), polyphenylene sulfide (PPS), polyphenylene ether (PPE), polyphenylene oxide-polystyrene blends, polystyrene, high-impact modified polystyrene, acrylonitrile-butadiene-styrene (ABS) terpolymer, polyetherimide (PEI), polyurethane, polyaryletherketone (PAEK) such as PEEK, poly ether sulphone (PES), or thermosets, as well as copolymers or mixtures of any of the foregoing.

According to one embodiment, exemplary polymers compositions for the base polymer resin can include nylon (PA6), polycarbonate, polyetherimide, polyetheretherketone, liquid crystal polymer, polyphenylene ether, polyphenylene sulfide, thermosets, or copolymers or mixtures of any of the foregoing. According to a further embodiment, nylon 6 (PA6) and polycarbonate are preferred.

According to one embodiment the base polymer resin can constitute from about 20 wt. % to about 80 wt. % of the polymer composite such that according to one embodiment, the base polymer resin constitutes at least about 20 wt. % of the polymer composite, and according to another embodiment the base polymer resin constitutes no greater than about 80 wt. % of the polymer composite. According to a further embodiment, the base polymer resin can constitute from about 20 wt. % to about 50 wt. % of the polymer composite such that according to one embodiment, the base polymer resin constitutes no greater than 50 wt. % of the polymer composite. According to a still further embodiment the base polymer resin can constitute from about 50 wt. % to about 80 wt. % of the polymer composite such that according to one embodiment, the base polymer resin constitutes at least about 50 wt. % of the polymer composite. In one exemplary embodiment, the base polymer resin can constitute from about 40 wt. % to about 50 wt. % of the polymer composite, for example about 40 wt. %, 41 wt. %, 42 wt. %, 43 wt. %, 44 wt. %, 45 wt. %, 46 wt. %, 47 wt. %, 48 wt. %, 49 wt. %, or 50 wt. %. In another exemplary embodiment, the base polymer resin can constitute from about 60 wt. % to about 70 wt. % of the polymer composite, for example about 60 wt. %, 61 wt. %, 62 wt. %, 63 wt. %, 64 wt. %, 65 wt. %, 66 wt. %, 67 wt. %, 68 wt. %, 69 wt. %, or 70 wt. %.

### Thermoconductive Filler Material

According to the present disclosure, the polymer composite can include a thermoconductive filler material. The thermoconductive filler material can be in the form of thermoconductive particles, and have an inherent thermal conductivity of at least 2 W/m*K. In one exemplary embodiment, the surface of the thermoconductive particles has an electronegative surface functionality that promotes integration with the compatibilizer and the base polymer resin. According to one embodiment, the surface of the thermoconductive particles has a plurality of electronegative functional groups. Suitable electronegative functional groups can include hydroxyl (OH—), oxides (e.g., monoxides, dioxides, trioxides, tetroxides, etc.), carbonate (CO₃²⁻), sulfate (SO₄²⁻), silicates (e.g., SiF₆²⁻, SiO₄⁴⁻), titanates (e.g., TiO₄⁴⁻, TiO₃²⁻, nitride (N³⁻), phosphide (P³⁻), sulfide (S²⁻), carbides, or combinations or mixtures of any of the foregoing.

Suitable compounds constituting the thermoconductive particles can generally include metal salts, metal oxides, metal hydroxides and combinations and mixtures of the foregoing. According to one embodiment, suitable compositions constituting the thermoconductive filler material having electronegative functionality can include, for example, aluminum oxide hydroxides including boehmite γ-AlO(OH), diaspore α-AlO(OH), and gibbsite Al(OH)₃, or magnesium hydroxide Mg(OH)₂; oxides such as calcium oxide CaO, magnesium oxide MgO, zinc oxide ZnO, titanium dioxide TiO₂, tin dioxide SnO₂, chromium oxides including chromium(II) oxide CrO, chromium(III) oxide Cr₂O₃, chromium dioxide (chromium(IV) oxide) CrO₂, chromium trioxide (chromium(VI) oxide) CrO₃, and chromium(VI) oxide peroxide CrO₅, barium oxide BaO, silicon dioxide SiO₂, zirconium dioxide ZrO₂, magnesium aluminate MgO*Al₂O₃, aluminum oxide Al₂O₃, or beryllium oxide BeO; carbonates such as calcium carbonate CaCO₃, or calcium magnesium carbonate (Dolomite) CaMg(CO₃)₂; sulfates such as barium sulfate BaSO₄, or calcium sulfate CaSO₄; silicates such as zinc silicate, mica, glass beads/fibers, calcium silicate (wollastonite) CaSiO₃, magnesium silicate (talc) H₂Mg₃(SiO₃)₄/Mg₃Si₄O₁₀(OH)₂, or clay; nitrides such as aluminum nitride AlN, boron nitride BN, aluminum oxynitride AlON, magnesium silicon nitride MgSiN₂, or silicon nitride Si₃N₄; phosphides such as aluminum phosphide AlP, or boron phosphide BP; sulfides such as cadmium sulfide CdS or zinc sulfide ZnS; and, carbides such as aluminum carbide Al₄C₃, or silicon carbide SiC, or combinations or mixtures thereof.

According to an additional embodiment, the thermoconductive filler material may include thermoconductive particles having relatively little to no inherent surface functionality (i.e., inert). In such embodiments where it is desirable to use otherwise inert thermoconductive particles, the surface of those particles can be processed or treated such that the surface of the particles can become electronegatively functionalized. For example, certain desired thermoconductive materials include those carbon-based compositions of primarily chemically inert carbon such as graphite, graphene, carbon fiber, expanded graphite, etc. The functionally inert thermoconductive materials can be processed to impart surface functionality through surface treatments or coatings resulting in an electronegative surface functionality in order to promote integration with the other components of the polymer composites. According to one embodiment, the thermoconductive filler material includes particles of inert carbon-based compositions having a coated surface such that the surface of the thermoconductive particles has an electronegative functionality. In another embodiment the thermoconductive particles include particles of inert carbon-based compositions having a treated surface such that the surface of the thermoconductive particles has an electronegative functionality. According to a further embodiment, suitable surface treatments or coatings can include treatment or coatings of stearic acid, silane, amines, quaternary ammonium salts, esterquats, or titanic acid.

According to one embodiment, the thermoconductive particles can have a particle morphology including any one of spheres, flakes, granules, fibers, filaments, cuboids, or ellipsoids, and can have both regular and irregular dimensions. It should be appreciated that the thermoconductive filler material can include blends and mixtures of thermoconductive particles having varying morphology. According to one embodiment, the thermoconductive filler material has a homogenous particle morphology. In an alternative embodiment, the thermoconductive filler material has a heterogeneous particle morphology. According to one embodiment, the thermoconductive filler material has thermoconductive particles substantially within the size range of about 100 nm to about 1000 μm. As used herein “size range” when referring to a linear measurement is the length of the longest cross-sectional linear dimension of the particle (e.g., major axis). According to one embodiment, the thermoconductive particles can have an aspect ratio in the range of about 1 to about 500. As used herein, “aspect ratio” is the measurement of a particle's longest cross-dimensional length divided by the particle's shortest cross-dimensional length; i.e., major axis divided by minor axis. In one embodiment, substantially all of the particles constituting the thermoconductive filler material have an aspect ratio greater than 1 to about 500; for example, about 1.5 to about 500, about 2.0 to about 500, about 2.5 to about 500, about 5 to about 500, about 10 to about 500, etc. According to still another embodiment, the thermoconductive particles can have surface area of about 0.1 m²/g to about 500 m²/g.

According to one embodiment, the thermoconductive filler material has an inherent thermal conductivity in the range of at least 2 W/m*K to about 500 W/m*K; for example, such as about 2 W/m*K to about 5 W/m*K, about 2 W/m*K to about 10 W/m*K, about 5 W/m*K to about 10 W/m*Km, about 2 W/m*K to about 50 W/m*K, about 10 W/m*K to about 50 W/m*K, about 10 W/m*K to about 20 W/m*K, about 20 W/m*K to about 50 W/m*K, about 50 W/m*K to about 500 W/m*K, about 50 W/m*K to about 100 W/m*K, about 50 W/m*K to about 150 W/m*K, about 150 W/m*K to about 500 W/m*K, or about 100 W/m*K to about 500 W/m*K.

According to one embodiment the thermoconductive filler material can constitute from about 1 wt. % to about 70 wt. % of the polymer composite such that according to one embodiment, the thermoconductive filler material constitutes at least about 1 wt. % of the polymer composite, and according to another embodiment, the thermoconductive filler material constitutes no greater than about 70 wt. % of the polymer composite. According to a further embodiment, thermoconductive filler material can constitute from about 1 wt. % to about 35 wt. % of the polymer composite such that according to one embodiment, thermoconductive filler material constitutes no greater than 35 wt. % of the polymer composite. According to a still further embodiment the thermoconductive filler material can constitute from about 35 wt. % to about 70 wt. % of the polymer composite such that according to one embodiment, the thermoconductive filler material constitutes at least about 35 wt. % of the polymer composite. In one exemplary embodiment, the thermoconductive filler material can constitute from about 30 wt. % to about 40 wt. % of the polymer composite, for example about 30 wt. %, 31 wt. %, 32 wt. %, 33 wt. %, 34 wt. %, 35 wt. %, 36 wt. %, 37 wt. %, 38 wt. %, 39 wt. %, or 40 wt. %. In another exemplary embodiment, the thermoconductive filler material can constitute from about 50 wt. % to about 60 wt. % of the polymer composite, for example about 50 wt. %, 51 wt. %, 52 wt. %, 53 wt. %, 54 wt. %, 55 wt. %, 56 wt. %, 57 wt. %, 58 wt. %, 59 wt. %, or 60 wt. %.

### Compatibilizer

According to the present disclosure the polymer composite can include a compatibilizer, such as an amphiphilic compatibilizer. The amphiphilic compatibilizer, according to one embodiment, includes a hydrophilic component and a hydrophobic chain component. The hydrophilic component can include, according to one embodiment, one or more functional groups including thiol, quaternary ammonium, carboxylic acid, carboxylate, amine, amide, hydroxyl, epoxide, sulfonic acid, and anhydrides, and mixtures of any of the foregoing. According to one embodiment, the hydrophobic chain component has a minimum chain unit length of at least 6 units. The units can comprise saturated or unsaturated aliphatic carbon, aromatic carbon, or silicone, including silicone saturated with alkyl or aromatic carbon, or mixtures of the foregoing. According to one embodiment, the amphiphilic compatibilizer can include fatty acids having a chain length longer than 6, such as, for example, stearic acid. According to another embodiment, the amphiphilic compatibilizer can include maleic anhydride grafted (MAH-g) polyalkene copolymers such as, for example, ethylene-propylene polymer (MAH-g-EPM), ethylene-propylene-diene terpolymer (MAH-g-EPDM), ethylene-octene copolymer (MAH-g-POE), ethylene-butene copolymer (MAH-g-EBR), styrene-ethylene/butadiene-styrene (MAH-g-SEBS), or combinations of any of the foregoing. According to a further embodiment, the amphiphilic compatibilizer can include poly(acrylic acid) (also known as acrylate acid) such as, for example, sodium polyacrylate.

According to one embodiment, the compatibilizer constitutes from about 1 wt. % to about 15 wt. % of the polymer composite such that according to one embodiment, the compatibilizer constitutes at least about 1 wt. % of the polymer composite, and according to another embodiment the compatibilizer constitutes no greater than about 15 wt. % of the polymer composite. According to a preferred embodiment, the compatibilizer constitutes from about 1 wt. % to about 5 wt. % of the polymer composite such that according to one embodiment, the compatibilizer constitutes at least about 1 wt. % of the polymer composite, and according to another embodiment the compatibilizer constitutes no greater than about 5 wt. % of the polymer composite. As such, in certain embodiments, the compatibilizer can constitute about 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3.0 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4.0 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, to about 5.0 wt. % of the polymer composite.

### Additives

According to the present disclosure, the polymer composites can optionally include one or more additives. The one or more additives are included in the polymer composites to impart one or more selected characteristics to polymer composites and any molded article made therefrom. Suitable additives can include, heat stabilizers, process stabilizers, antioxidants, light stabilizers, plasticizers, antistatic agents, mold releasing agents, UV absorbers, lubricants, pigments, dyes, colorants, flow promoters, flame retardants, or a combination of one or more of the foregoing additives. According to one embodiment, the one or more additives constitute from about 0.1 wt. % to about 50 wt. % of the polymer composite such that according to one embodiment, the one or more additives constitute at least about 0.1 wt. % of the polymer composite, and according to another embodiment the one or more additives constitute no greater than about 50 wt. % of the polymer composite.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of about 0.1 wt. % to about 0.5 wt. % of the polymer composite.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of about 0.1 wt. % to about 0.5 wt. % of the polymer composite.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of about 0.1 wt. % to about 1.0 wt. % of the polymer composite.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of about 0.5 wt. % to about 3.0 wt. % of the polymer composite.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of about 0.1 wt. % to about 1.0 wt. % of the polymer composite.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™0 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1- benzoxazin-4-one) (CYASORB™ UV-3638); 1,3-bis[(2-cyano-3,3-diphenylacryloyl)oxy]-2,2-bis[[2-cyano-3,3-diphenylacryloy)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of about 0.1 wt. % to about 3.0 wt. % of the polymer composite.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of about 1.0 wt. % to about 10 wt. % of the polymer composite.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenyl)-6-phenylbenzoxazole-1,3;2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IR 5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of about 0.1 wt. % to about 5 wt. % of the polymer composite.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), napthalenetetracarboxylic derivatives, monoazo and disazo pigments, triarylmethanes, aminoketones, bis(styryl)biphenyl derivatives, and the like, as well as combinations including at least one of the foregoing colorants. Colorants are generally used in amounts of about 0.1 wt. % to about 5 wt. % of the polymer composite.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of about 1.0 wt. % to about 20 wt. % of the polymer composite.

Suitable flame retardants include, but are not limited to, halogenated flame retardants, like tretabromo bisphenol A oligomers such as BC58 and BC52, brominated polystyrene or poly(dibromo-styrene), brominated epoxies, decabromodiphenyleneoxide, pentabrombenzyl acrylate monomer, pentabromobenzyl acrylate polymer, ethylene-bis(tetrabromophthalimide, bis(pentabromobenzyl)ethane, metal hydroxides like Mg(OH)₂ and Al(OH)₃, melamine cyanurate, phosphor based flame retardant systems like red phosphorus, melamine polyphosphate, phosphate esters, metal phosphinates, ammonium polyphosphates, expandable graphites, sodium or potassium perfluorobutane sulfate, sodium or potassium perfluorooctane sulfate, sodium or potassium diphenylsulfone sulfonate and sodium- or potassium-2,4,6-trichlorobenzoate and N-(p-tolylsulfonyl)-p-toluenesulfimide potassium salt, N-(N′-benzylaminocarbonyl) sulfanylimide potassium salt, or a combination containing at least one of the foregoing. Flame retardants are generally used in amounts of about 1.0 wt. % to about 60 wt. % of the polymer composite, such as for example in amounts of about 1.0 wt. % to about 50 wt. % of the polymer composite.

### Processing of the Polymer Composite

According to one embodiment, the components of the thermally-conductive polymer composite may first be dry blended together, then fed into an extruder from a single feeder or a multi-feeder, or in an alternative embodiment, each component can be separately fed into extruder. For example, the base polymer resin may, where it includes multiple polymer components, be first dry blended together, or dry blended with any combination of foregoing mentioned thermoconductive fillers, compatibilizers, or additives, then fed into an extruder from a single feeder a or multi-feeder, or separately fed into extruder from a single feeder a or multi-feeder. The thermoconductive fillers used in the invention may also be first processed into a master batch, and then fed into an extruder.

The feeding of the base polymer resin polymers, amphiphilic compatibilizer, additives, thermoconductive fillers and reinforcing agents, or any combination or mixture thereof may be fed into an extruder from a throat hopper or a side feeder.

The extruders used in the invention may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations including at least one of the foregoing. The melt blending of the composites involves the use of shear force, extensional force, compressive force, ultrasonic energy, electromagnetic energy, thermal energy or combinations including at least one of the foregoing forces or forms of energy.

The barrel temperature on the extruder during compounding can be set at a temperature or within a temperature range where at least a portion of the organic polymer has reached a temperature greater than or equal to about the melting temperature, if the resin is a semi-crystalline organic polymer, or the flow point (e.g., the glass transition temperature) if the resin is an amorphous resin.

The polymer composite may be subject to multiple blending and forming steps if desirable prior to forming the resultant moldable article. For example, the polymer composite may first be extruded and formed into pellets. The pellets may then be fed into a molding machine where it may be formed into an article of manufacture of any shape or product as desired. Alternatively, the polymer composite can emanate from a single melt blender and subsequently be formed into sheets or strands and then further subjected to post-extrusion processes such as annealing, or uniaxial or biaxial orientation.

Solution blending may also be used to manufacture the resultant moldable article formed from the polymer composite. Solution blending may also use additional energy such as shear, compression, ultrasonic vibration, or the like, to promote homogenization of the components of the polymer composite. In one embodiment, the polymer composite is formed by suspending the base polymer resin in a fluid (for example, forming a colloidal mixture or suspension) and then placing the suspension into an ultrasonic sonicator along with any one of, or all of the described thermoconductive filler material, compatibilizer, or additives. The thermoconductive filler material, compatibilizer, or additives can be introduced into the suspension either singly or in combination, and can be introduce prior to the placement of the suspension into the sonicator or during the process of sonicating the suspension. The composition may be solution blended by sonication for a time period effective to disperse the components among the base polymer resin. The polymer composite may then be dried, extruded and molded in to an article of manufacture as desired.

According to one preferred embodiment, the polymer composite includes a polyamide as the base polymer resin, magnesium hydroxide or boron nitride as the thermoconductive filler material, and stearic acid or MAH-g-EPM as the compatibilizer, with the addition of a mold release agent. In a particularly preferred embodiment the thermally-conductive polymer composite includes (a) from about 40 wt. % to about 70 wt. % of a polyamide; (b) from about 25 wt. % to about 55% of magnesium hydroxide or boron nitride or a combination thereof; (c) from about 2.0 wt. % to about 3.0 wt. % of steric acid or MAH-g-EPM or a combination thereof; and, (d) from about 0.2 wt. % to 1 wt. % of a mold release agent; where the combined weight percent value of all components does not exceed about 100 wt. %, and where all weight percent values are based on the total weight of the composition. In this particularly preferred embodiment; the polymer composite, as compared to a control composition having 0.00 wt. % of component (c), the composite has an (i) increase of about 20% to about 45% mechanical strength as measured by Izod impact testing, and, an (ii) increase of about 4% to about 25% thermal conductivity as measured by through-plane and in-plane testing.

### EXAMPLES

TABLE 1
Raw Materials

| Component | CHEMICAL DESCRIPTION | SOURCE |
|---|---|---|
| PA6 Regular | Nylon 6 (PA6) [CAS: 25038-54-4] | BASF Kyowa |
| Ultramid B27 | | |
| MAGNESIUM | Mg(OH)₂ [CAS: 1309-42-8] | Albemarle |
| HYDROXIDE, | | |
| MAGNIFIN H5-IV | | |
| MAGNESIUM | Mg(OH)₂ [CAS: 1309-42-8] | Songyuan |
| HYDROXIDE, | | chemical |
| KISUMA 5-C | | |
| BNHN | Boron nitride [CAS: 10043-11-5] | Dandong |
| | | chemical |
| | | Institute |
| STEARIC ACID | Stearic acid [CAS: 57114] | ALFA AESAR, |
| | | JOHNSON |
| | | MATTHEY |
| | | COMPANY |
| Exxelor 1801 | MAH-g-EPM | Exxon Mobil |

Sample Preparation

In this embodiment, samples were prepared using a twin screw extruder (Toshiba TEM-37BS, L/D=40.5), the temperature of the extruder barrel was set at 260° C. Pellets extruded from extruder were first injection molded into 10 mm*10 mm*0.8 mm bars for flame retardant measurements, and then 80 mm*10 mm*3 mm bars were injection molded and cut into 10 mm*10 mm*3 mm samples for thermal conductivity measurements.

Thermal conductivity (K, W/m-K), was measured by a Nanoflash LFA447 using a reference sample of Pyrex 7740 with similar thickness according to ASTM E1461 (at approximately room temperature, e.g, 25° C.). The measurement determines the thermal diffusivity (α, cm²/s) and the specific heat (Cp, J/g-K) of the sample, together with the density (ρ, g/cm³) which is measured using a water immersion method (ASTM D792), the product of three value gives the thermal conductivity in the through plane direction and in plane direction, according to: K=α(T) Cp(T) ρ(T).

### Examples 1-2

The values described in Table 2 were obtained from polymer composites including nylon 6 (PA6) as the base polymer resin and magnesium hydroxide (Kisuma 5-C) as thermoconductive filler. The data show the comparative TC (thermal conductivity) and mechanical performance of a polymer composite according to the present disclosure, Ex. 2, with the amphiphilic compatibilizer (in this embodiment, stearic acid), as compared to a control composition, Ex. 1, without the compatibilizer. As demonstrated in Table 2, between sample Ex. 1 (control composition) and Ex. 2, with addition of 3 wt. % of stearic acid there are increases in both thermal conductivity and mechanical performance. The through-plane TC was increased by 13.8% and in-plane TC was increased by 22.4%. The Notched Izod Impact (NII) value was increased by 42% and Unnotched Izod Impact (UNI) was increased by 35%. Both NII and UNI values were measured and determined according to ASTM D2556, and measure a material's capability to resist impact damage.

TABLE 2
TC and mechanical performance using stearic acid.

| Component | Unit | Ex. 1 | Ex. 2 |
|---|---|---|---|
| PA6 Regular | Wt. % | 44.7 | 41.7 |
| Kisuma 5-C | Wt. % | 55 | 55 |
| Mold release | Wt. % | 0.3 | 0.3 |
| Stearic Acid | Wt. % | 0 | 3 |
| Through plane TC | W/(m · K) | 0.736 | 0.838 |
| In plane TC | W/(m · K) | 1.32 | 1.616 |
| NII Impact Strength | J/m | 33.6 | 47.8 |
| UNI, Impact Strength | J/m | 492 | 666 |

### Examples 3-6

The values described in Table 3 were obtained from polymer composites including nylon 6 (PA6) as the base polymer resin, and boron nitride (BNHN) (Exs. 3-4) and magnesium hydroxide (H5-IV) (Exs. 5-6) as the thermoconductive filler. The data show the comparative TC (thermal conductivity) and mechanical performance of polymer composites according to the present disclosure (Exs. 4 and 6), with the amphiphilic compatibilizer (in this embodiment, maleic anhydride-grafted ethylene-propylene polymer (MAH-g-EPM)), as compared to a respective control composition (Exs. 3 and 5), without the compatibilizer. As demonstrated in Table 3, between sample Ex. 3 (control composition) and Ex. 4, with addition of 2 wt. % of MAH-g-EPM, there are increases in both thermal conductivity and mechanical performance. The through-plane TC was increased by 4.9% and in-plane TC was increased by 6.7%. The Notched Izod Impact (NII) value was increased by about 4.0% and Unnotched Izod Impact (UNI) was increased by 22.7%. As between sample Ex. 5 (control composition) and Ex. 6, with addition of 2 wt. % of MAH-g-EPM, there are increases in both thermal conductivity and mechanical performance. The in-plane TC was increased by 18%. The Notched Izod Impact (NII) value was increased by about 34.9% and Unnotched Izod Impact (UNI) was increased by 20.8%.

TABLE 3
TC and mechanical performance using MAH-g-EPM.

| Component | Unit | Ex. 3 | Ex. 4 | Ex. 5 | Ex. 6 |
|---|---|---|---|---|---|
| PA6 Regular | Wt. % | 70 | 68 | 65 | 63 |
| BNHN | Wt. % | 30 | 30 | 0 | 0 |
| H5-IV | Wt. % | 0 | 0 | 35 | 35 |
| MAH-g-EPM | Wt. % | 0 | 2 | 0 | 2 |
| Through plane TC | W/(m · K) | 0.938 | 0.984 | 0.593 | 0.611 |
| In plane TC | W/(m · K) | 3.016 | 3.218 | 1.08 | 1.203 |
| NII Impact | J/m | 32.9 | 34.2 | 40.9 | 55.2 |
| Strength | | | | | |
| UNI Impact | J/m | 326 | 400 | 1150 | 1390 |
| Strength | | | | | |

Overall, the data above demonstrates that the polymer composites (and articles formed therefrom) of the present disclosure including the combination of an amphiphilic compatibilizer with a base polymer resin and a thermoconductive filler material having electronegative surface functionality can have improved thermal conductivity and mechanical performance as compared to a control composition having no compatibilizer. According to one embodiment, the polymer composites of the present disclosure can have at least 4.0%, up to and including a 300.0% increase in thermal conductivity (as measured either by in plane or through plane thermal conductivity) as compared to a control composition having no compatibilizer. According to another embodiment, the polymer composites of the present disclosure can have at least 4.0%, up to and including a 300.0% increase in impact resistance (as measured either by NII or UNI. As such, the polymer composites of the present disclosure can have, for example, 5.0%, 10.0%, 50.0%, 75.0%, 100.0%, 150.0%, 200.0%, 250.0%, and up to and including a 300.0% increase in either thermal conductivity (as measured either by in plane or through plane thermal conductivity) as compared to a control composition having no compatibilizer, or impact resistance (as measured either by NII or UNI. According to one embodiment, the polymer composites of the present disclosure can have at least 4.0%, up to and including a 50.0% increase in thermal conductivity (as measured either by in plane or through plane thermal conductivity) as compared to a control composition having no compatibilizer, such as for example at least 5.0% to about 25.0% increase in thermal conductivity. According to another embodiment, the polymer composites of the present disclosure can have at least 5.0%, up to and including a 50.0% increase in impact resistance (as measured either by NII or UNI.

The present disclosure includes the following aspects:

Aspect 1. A thermally-conductive polymer composite comprising:
(a) from about 20 wt. % to about 80 wt. % of a base polymer resin;
(b) from about 1 wt. % to about 70 wt. % of thermoconductive filler material comprising thermoconductive particles having a plurality of electronegative functional groups at the surface of the particles, and having a thermal conductivity of at least 2 W/m*K;
(c) from about 0.01 wt. % to about 20 wt. % of an amphiphilic compatibilizer comprising a hydrophilic component and hydrophobic chain component; and, optionally,
(d) from about 0 wt. % to 50 wt. % of an additive;
wherein the combined weight percent value of all components does not exceed about 100 wt. %, and wherein all weight percent values are based on the total weight of the composition;
wherein, as compared to a control composition having 0.00 wt. % of the amphiphilic compatibilizer, the composite has (i) increased mechanical strength as measured by Izod impact testing, and, (ii) increased thermal conductivity as measured by through-plane or in-plane testing.

Aspect 2. The thermally-conductive polymer composite of aspect 1, wherein the base polymer resin comprises a polyalkene, polycarbonate, polyamide, polyimide, polyester, polyacrylate, aromatic polymer, polyurethane, thermoset, or copolymers or mixtures of any of the foregoing.

Aspect 3. The thermally-conductive polymer composite according to aspect 2, wherein the base polymer resin comprises a polyamide, aromatic polymer, polycarbonate, thermoset, or copolymers or mixtures of any of the foregoing.

Aspect 4. The thermally-conductive polymer composite according to aspect 3, wherein the base polymer resin comprises nylon 6, polycarbonate, polyetherimide, polyaryletherketone, liquid crystal polymer, polyphenylene ether, polyphenylene sulfide, thermoset, or copolymers or mixtures of any of the foregoing.

Aspect 5. The thermally-conductive polymer composite of any one of the preceding aspects, wherein the electronegative functional groups comprise hydroxyl, oxides, carbonate, sulfate, silicates, titanates, nitride, phosphide, sulfide, carbides, or combinations or mixtures of any of the foregoing.

Aspect 6. The thermally-conductive polymer composite of any one of the preceding aspects, wherein the thermoconductive particles comprise a metal salt, metal oxide, metal hydroxide, or mixtures of any of the foregoing.

Aspect 7. The thermally-conductive polymer composite of any one of the preceding aspects, wherein the thermoconductive particles have an average cross-sectional length along a major axis in the range of about 100 nm to about 1000 um.

Aspect 8. The thermally-conductive polymer composite of any one of the preceding aspects, wherein the thermoconductive particles have an average aspect ratio in the range of about 1 to about 500.

Aspect 9. The thermally-conductive polymer composite of any one of the preceding aspects, wherein the thermoconductive particles have an average thermal conductivity in the range of 2 W/m*K to 10 W/m*K.

Aspect 10. The thermally-conductive polymer composite of any one of aspects 1-8, wherein the thermoconductive particles have an average thermal conductivity in the range of 10 W/m*K to 50 W/m*K.

Aspect 11. The thermally-conductive polymer composite of any one of aspects 1-8, wherein the thermoconductive particles have an average thermal conductivity in the range of 50 W/m*K to 150 W/m*K.

Aspect 12. The thermally-conductive polymer composite of any one of the preceding aspects, wherein the hydrophilic component includes one or more functional groups selected from the group consisting of: quaternary ammonium, esterquats, carboxylic acid, carboxylate, amine, amide, hydroxyl, epoxide, sulfonic acid, and anhydride, and mixtures of any of the foregoing.

Aspect 13. The thermally-conductive polymer composite of any one of the preceding aspects, wherein the hydrophobic component comprises saturated or unsaturated aliphatic carbon, aromatic carbon, or silicone, including silicone saturated with alkyl or aromatic carbon, or mixtures of the foregoing, the hydrophobic component having a minimum chain length of at least 6.

Aspect 14. The thermally-conductive polymer composite of any one of the preceding aspects, wherein the amphiphilic compatibilizer is selected from the group consisting of stearic acid, acrylate acid, maleic anhydride grafting polyethylene copolymers including ethylene-propylene polymer (MAH-g-EPM), ethylene-propylene-diene terpolymer (MAH-g-EPDM), ethylene-octene copolymer (MAH-g-POE), ethylene-butene copolymer (MAH-g-EBR), styrene-ethylene/butadiene-styrene (MAH-g-SEBS), and combinations of any of the foregoing.

Aspect 15. The thermally-conductive polymer composite of any one of the preceding aspects, wherein the amphiphilic compatibilizer constitutes 1 wt. % to 5 wt. % of the composite.

Aspect 16. The thermally-conductive polymer composite of any one of the preceding aspects, wherein the amphiphilic compatibilizer constitutes 2 wt. % to 3 wt. % of the composite.

Aspect 17. The thermally-conductive polymer composite of any one of the preceding aspects, wherein the additive comprises reinforcing filler, flame retardant, mold release agent, anti-oxidant, or UV stabilizer, or any combination of the foregoing.

Aspect 18. A thermally-conductive polymer composite comprising:
(a) from about 40 wt. % to about 70 wt. % of a polyamide;
(b) from about 25 wt. % to about 55% of magnesium hydroxide or boron nitride or a combination thereof;
(c) from about 2.0 wt. % to about 3.0 wt. % of steric acid or MAH-g-EPM or a combination thereof; and,
(d) from about 0.2 wt. % to 1 wt. % of a mold release agent;
wherein the combined weight percent value of all components does not exceed about 100 wt. %, and wherein all weight percent values are based on the total weight of the composition;
wherein, as compared to a control composition having 0.00 wt. % of component (c), the composite has an (i) increase of about 5.0% to about 50.0% mechanical strength as measured by Izod impact testing, and, an (ii) increase of about 4.0% to about 25.0% thermal conductivity as measured by through-plane or in-plane testing.

Aspect 19. An article formed from the polymer composite of any preceding aspect.

Aspect 20. The article of aspect 19, wherein the article is a molded article.

Aspect 21. A thermally-conductive polymer composite comprising:
(a) from about 20 wt. % to about 80 wt. % of a base polymer resin;
(b) from about 1 wt. % to about 70 wt. % of thermoconductive filler material comprising thermoconductive particles having a plurality of electronegative functional groups at the surface of the particles, and having a thermal conductivity of at least 2 W/m*K;
(c) from about 0.01 wt. % to about 20 wt. % of an amphiphilic compatibilizer comprising a hydrophilic component and hydrophobic chain component; and, optionally,
(d) from about 0 wt. % to 50 wt. % of an additive;
wherein the combined weight percent value of all components does not exceed about 100 wt. %, and wherein all weight percent values are based on the total weight of the composition;
wherein, as compared to a control composition consisting essentially of the same components as the thermally-conductive polymer composite but without the amphiphilic compatibilizer, the composite has (i) increased mechanical strength as measured by Izod impact testing, and, (ii) increased thermal conductivity as measured by through-plane or in-plane testing.

Aspect 22. A thermally-conductive polymer composite comprising:
(a) from about 20 wt. % to about 80 wt. % of a base polymer resin;
(b) from about 1 wt. % to about 70 wt. % of thermoconductive filler material comprising thermoconductive particles having a plurality of electronegative functional groups at the surface of the particles, and having a thermal conductivity of at least 2 W/m*K;
(c) from about 0.01 wt. % to about 20 wt. % of an amphiphilic compatibilizer comprising a hydrophilic component and hydrophobic chain component; and, optionally,
(d) from about 0 wt. % to 50 wt. % of an additive;
wherein the combined weight percent value of all components does not exceed about 100 wt. %, and wherein all weight percent values are based on the total weight of the composition;
wherein, as compared to a control composition consisting essentially of (a) from about 20 wt. % to about 80 wt. % of a base polymer resin, (b) from about 1 wt. % to about 70 wt. % of thermoconductive filler material comprising thermoconductive particles having a plurality of electronegative functional groups at the surface of the particles, and having a thermal conductivity of at least 2 W/m*K, and (c) 0.00 wt. % of the amphiphilic compatibilizer, the composite has (i) increased mechanical strength as measured by Izod impact testing, and, (ii) increased thermal conductivity as measured by through-plane or in-plane testing.

Aspect 23. The thermally-conductive polymer composite of aspect 21 or 22, wherein the base polymer resin comprises a polyalkene, polycarbonate, polyamide, polyimide, polyester, polyacrylate, aromatic polymer, polyurethane, thermoset, or copolymers or mixtures of any of the foregoing.

Aspect 24. The thermally-conductive polymer composite according to aspect 23, wherein the base polymer resin comprises a polyamide, aromatic polymer, polycarbonate, thermoset, or copolymers or mixtures of any of the foregoing.

Aspect 25. The thermally-conductive polymer composite according to aspect 24, wherein the base polymer resin comprises nylon 6, polycarbonate, polyetherimide, polyaryletherketone, liquid crystal polymer, polyphenylene ether, polyphenylene sulfide, thermoset, or copolymers or mixtures of any of the foregoing.

Aspect 26. The thermally-conductive polymer composite of any one of the preceding aspects, wherein the electronegative functional groups comprise hydroxyl, oxides, carbonate, sulfate, silicates, titanates, nitride, phosphide, sulfide, carbides, or combinations or mixtures of any of the foregoing.

Aspect 27. The thermally-conductive polymer composite of any one of the preceding aspects, wherein the thermoconductive particles comprise a metal salt, metal oxide, metal hydroxide, or mixtures of any of the foregoing.

Aspect 28. The thermally-conductive polymer composite of any one of the preceding aspects, wherein the thermoconductive particles have an average cross-sectional length along a major axis in the range of about 100 nm to about 1000 um.

Aspect 29. The thermally-conductive polymer composite of any one of the preceding aspects, wherein the thermoconductive particles have an average aspect ratio in the range of about 1 to about 500.

Aspect 30. The thermally-conductive polymer composite of any one of the preceding aspects, wherein the thermoconductive particles have an average thermal conductivity in the range of 2 W/m*K to 10 W/m*K.

Aspect 31. The thermally-conductive polymer composite of any one of aspects 1-8, wherein the thermoconductive particles have an average thermal conductivity in the range of 10 W/m*K to 50 W/m*K.

Aspect 32. The thermally-conductive polymer composite of any one of aspects 1-8, wherein the thermoconductive particles have an average thermal conductivity in the range of 50 W/m*K to 150 W/m*K.

Aspect 33. The thermally-conductive polymer composite of any one of the preceding aspects, wherein the hydrophilic component includes one or more functional groups selected from the group consisting of: quaternary ammonium, esterquats, carboxylic acid, carboxylate, amine, amide, hydroxyl, epoxide, sulfonic acid, and anhydride, and mixtures of any of the foregoing.

Aspect 34. The thermally-conductive polymer composite of any one of the preceding aspects, wherein the hydrophobic component comprises saturated or unsaturated aliphatic carbon, aromatic carbon, or silicone, including silicone saturated with alkyl or aromatic carbon, or mixtures of the foregoing, the hydrophobic component having a minimum chain length of at least 6.

Aspect 35. The thermally-conductive polymer composite of any one of the preceding aspects, wherein the amphiphilic compatibilizer is selected from the group consisting of stearic acid, acrylate acid, maleic anhydride grafting polyethylene copolymers including ethylene-propylene polymer (MAH-g-EPM), ethylene-propylene-diene terpolymer (MAH-g-EPDM), ethylene-octene copolymer (MAH-g-POE), ethylene-butene copolymer (MAH-g-EBR), styrene-ethylene/butadiene-styrene (MAH-g-SEBS), and combinations of any of the foregoing.

Aspect 36. The thermally-conductive polymer composite of any one of the preceding aspects, wherein the amphiphilic compatibilizer constitutes 1 wt. % to 5 wt. % of the composite.

Aspect 37. The thermally-conductive polymer composite of any one of the preceding aspects, wherein the amphiphilic compatibilizer constitutes 2 wt. % to 3 wt. % of the composite.

Aspect 38. The thermally-conductive polymer composite of any one of the preceding aspects, wherein the additive comprises reinforcing filler, flame retardant, mold release agent, anti-oxidant, or UV stabilizer, or any combination of the foregoing.

1. A thermally-conductive polymer composite comprising:
(a) from about 20 wt. % to about 80 wt. % of a base polymer resin;
(b) from about 1 wt. % to about 70 wt. % of thermoconductive filler material comprising thermoconductive particles having a plurality of electronegative functional groups at the surface of the particles, and having a thermal conductivity of at least 2 W/m*K;
(c) from about 0.01 wt. % to about 20 wt. % of an amphiphilic compatibilizer comprising a hydrophilic component and hydrophobic chain component; and, optionally,
(d) from about 0 wt. % to 50 wt. % of an additive;
wherein the combined weight percent value of all components does not exceed about 100 wt. %, and wherein all weight percent values are based on the total weight of the composition;
wherein, as compared to a control composition having 0.00 wt. % of the amphiphilic compatibilizer, the composite has (i) increased mechanical strength as measured by Izod impact testing, and, (ii) increased thermal conductivity as measured by through-plane or in-plane testing.

2. The thermally-conductive polymer composite of claim 1, wherein the base polymer resin comprises a polyalkene, polycarbonate, polyamide, polyimide, polyester, polyacrylate, aromatic polymer, polyurethane, thermoset, or copolymers or mixtures of any of the foregoing.

3. The thermally-conductive polymer composite of claim 2, wherein the base polymer resin comprises a polyamide, aromatic polymer, polycarbonate, thermoset, or copolymers or mixtures of any of the foregoing.

4. The thermally-conductive polymer composite of claim 3, wherein the base polymer resin comprises nylon 6, polycarbonate, polyetherimide, polyaryletherketone, liquid crystal polymer, polyphenylene ether, polyphenylene sulfide, thermoset, or copolymers or mixtures of any of the foregoing.

5. The thermally-conductive polymer composite of claim 1, wherein the electronegative functional groups comprise hydroxyl, oxides, carbonate, sulfate, silicates, titanates, nitride, phosphide, sulfide, carbides, or combinations or mixtures of any of the foregoing.

6. The thermally-conductive polymer composite of claim 1, wherein the thermoconductive particles comprise a metal salt, metal oxide, metal hydroxide, or mixtures of any of the foregoing.

7. The thermally-conductive polymer composite of claim 1, wherein the thermoconductive particles have an average cross-sectional length along a major axis in the range of about 100 nm to about 1000 um.

8. The thermally-conductive polymer composite of claim 1, wherein the thermoconductive particles have an average aspect ratio in the range of about 1 to about 500.

9. The thermally-conductive polymer composite of claim 1, wherein the thermoconductive particles have an average thermal conductivity in the range of 2 W/m*K to 10 W/m*K.

10. The thermally-conductive polymer composite of claim 1, wherein the thermoconductive particles have an average thermal conductivity in the range of 10 W/m*K to 50 W/m*K.

11. The thermally-conductive polymer composite of claim 1, wherein the thermoconductive particles have an average thermal conductivity in the range of 50 W/m*K to 150 W/m*K.

12. The thermally-conductive polymer composite of claim 1, wherein the hydrophilic component includes one or more functional groups selected from the group consisting of: quaternary ammonium, esterquats, carboxylic acid, carboxylate, amine, amide, hydroxyl, epoxide, sulfonic acid, and anhydride , and mixtures of any of the foregoing.

13. The thermally-conductive polymer composite of claim 1, wherein the hydrophobic component comprises saturated or unsaturated aliphatic carbon, aromatic carbon, or silicone, including silicone saturated with alkyl or aromatic carbon, or mixtures of the foregoing, the hydrophobic component having a minimum chain length of at least 6.

14. The thermally-conductive polymer composite of claim 1, wherein the amphiphilic compatibilizer is selected from the group consisting of stearic acid, acrylate acid, maleic anhydride grafting polyethylene copolymers including ethylene-propylene polymer (MAH-g-EPM), ethylene-propylene-diene terpolymer (MAH-g-EPDM), ethylene-octene copolymer (MAH-g-POE), ethylene-butene copolymer (MAH-g-EBR), styrene-ethylene/butadiene-styrene (MAH-g-SEBS), and combinations of any of the foregoing.

15. The thermally-conductive polymer composite of claim 1, wherein the amphiphilic compatibilizer constitutes 1 wt. % to 5 wt. % of the composite.

16. The thermally-conductive polymer composite of claim 1, wherein the amphiphilic compatibilizer constitutes 2 wt. % to 3 wt. % of the composite.

17. The thermally-conductive polymer composite of claim 1, wherein the additive comprises reinforcing filler, flame retardant, mold release agent, anti-oxidant, or UV stabilizer, or any combination of the foregoing.

18. A thermally-conductive polymer composite comprising:
(a) from about 40 wt. % to about 70 wt. % of a polyamide;
(b) from about 25 wt. % to about 55% of magnesium hydroxide or boron nitride or a combination thereof;
(c) from about 2.0 wt. % to about 3.0 wt. % of steric acid or MAH-g-EPM or a combination thereof; and,
(d) from about 0.2 wt. % to 1 wt. % of a mold release agent;
wherein the combined weight percent value of all components does not exceed about 100 wt. %, and wherein all weight percent values are based on the total weight of the composition;
wherein, as compared to a control composition having 0.00 wt. % of component (c), the composite has an (i) increase of about 5.0% to about 50.0% mechanical strength as measured by Izod impact testing, and, an (ii) increase of about 4.0% to about 25.0% thermal conductivity as measured by through-plane or in-plane testing.

19. An article formed from the polymer composite of claim 1.

20. The article of claim 19, wherein the article is a molded article.
